(19) United States
(12) Patent Application Publication
(10) Pub. No.: US 2007/0192601 A1
(43) Pub. Date: Aug. 16, 2007

(54) System and method for user identification and authentication

(76) Inventors: John D.R. Spain, Anniston, AL (US); Richard A. Lee, Alpharetta, GA (US); John D.R. Spain IV, Anniston, AL (US); Martin B. Bushman, Fullerton, CA (US); Scott. M. Volmar, Fullerton, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/462,258

(22) Filed: Aug. 3, 2006

Related U.S. Application Data
(60) Provisional application No. 60/705,336, filed on Aug. 3, 2005.

(51) Int. Cl. H04L 9/00

(52) U.S. Cl. 713/168

(57) ABSTRACT

A user identification and authentication device provides a secure computing platform and a secure computing path for communication with a secure remote host. The device is coupled to an unsecure PC but provides for secure verification of a user's identity and authorization in participating in a transaction.

### CROSS-REFERENCE TO RELATED APPLICATIONS

The present application claims priority benefit under 35 U.S.C. § 119(e) to U.S. Provisional Patent Application Ser. No. 60/705,336, filed Aug. 3, 2005, titled “System and Method for Authentication.” The present application incorporates the foregoing disclosure herein by reference.

### FIELD OF THE DISCLOSURE

The present invention relates to the field of identification and authentication of a user.

### BACKGROUND

The Internet is an important arena of communication for business transactions. The Internet provides a forum where buyers and sellers from all over the world can communicate and do business in both an efficient and effective manner. However, the Internet is also an open communication forum. That is to say, the traffic passing through the Internet can be viewed and manipulated by anyone having the knowledge to do so. Current computing platforms are inherently unsecured. Even where a communication is encrypted before being sent through the Internet, the transaction may be compromised at either the sending or receiving device. Because of the inherent unsecured nature of network communication and communication devices, many transactions are not performed over a network, such as the Internet.

### SUMMARY OF THE DISCLOSURE

Aspects of the present disclosure include systems and methods for securing communications and devices for communication over an unsecured communication path. An authentication device provides modular identification and authentication for users of a secure messaging system.

In one embodiment, the authentication device is used in connection with an authentication process to provide multi-level access controls and authorization controls. In one embodiment, inherent in the design of the device is the generation of secret/public key pairs. These key pairs, in combination with a trusted remote host and protected key management, prevent the device from being cloned or the key pairs from being replicated by others. Via the trusted remote host and key management, the public key is combined into independently-verifiable public key certificates, which generally only “fail securely” if altered after they are released to the public directory service. In addition, the device capabilities are instantly revocable by removing the directory service public key certificate. In one embodiment, the authentication device provides modular encryption. In one embodiment, a portable audit file provides audit and forensic capabilities. In one embodiment, the authentication device is used in connection with an evaluatable infrastructure. This creates a trusted computing base with one-way communication and a trusted path between the trusted computing base and the one or more authentication servers (also referred to herein as an ICN server).

In one embodiment, the authentication device is configured as a computer peripheral device that can be connected to a user's computer and used to establish both a Trusted Computing Base and a Trusted Path between a non-secure user computer and the authentication servers. The authentication servers provide a relatively high level of security to ensure that transactions are secure and insurable. Using the authentication device along with the authentication servers and following established security procedures provides relatively high assurance to the user that communication between the user's computer and the authentication servers is authenticated and secure. In one embodiment, the system provides a three factor authentication including: a unique biometric identification, such as for example a thumbprint, fingerprint, or retinal scanner, etc.; a unique device identification; and a secret code (such as a password, pass code, etc.). In one embodiment, the device can capture an electronic signature either from the display or from an electronic signature pad.

In one embodiment, the authentication device is provided to the user's computer (e.g., a personal computer, data terminal, etc.) using computer peripheral connection such as, for example, a USB connection, an IEEE 1394 firewire connection, Bluetooth, or the like. The user's computer passes encrypted communication between the authentication device and the authentication servers. The contents of the pass-through data cannot be decrypted or seen by the user's computer. The authentication device provides a desired level of security and authentication by using one or more of: authentication capabilities, monitoring capabilities, data confirmation, auditing capabilities, out-of-band communication, forensics, ability to track data tampering, and/or detect abuse.

In the secure communication environment, the authentication device receives incoming secure (e.g., encrypted) messages before they are routed to a software client on the user's computer. This creates a secure communication path between the authentication servers and the authentication device. This secure communication facilitates the establishment of a trusted path between the authentication servers and the authentication device.

In one embodiment, the authentication device interacts with the authentication servers to provide a key management infrastructure. Each authentication device is given a distinct digital private key. Firmware that runs on the authentication device is signed by a digital private key located in the key management infrastructure. In addition, the authentication device cannot be activated or deactivated without interaction with the key management infrastructure, where tokens for activation, deactivation, and canceling of the authentication device are stored.

In one embodiment, an authorized person can inspect and compare an on-board audit file stored in the authentication device to normalized patterns and/or to an audit file maintained by one or more of the authentication servers or the host system.

In one embodiment, the authentication device allows the user or security personnel to inspect in parallel the transaction information on the user's computer screen with the information on the authentication device screen in real-time.

In one embodiment, the authentication device creates its own independent audit file of actions performed on the authentication device. This file can be uploaded to the server, but is independent from the audit files created by the servers.

In one embodiment, communication between the authentication device and the authentication servers is encrypted and the user's computer is only “allowed” to “see” or have access to a limited amount of pre-determined data.

In one embodiment, authorized personnel can inspect the on-board audit file for the authentication device to determine what actions a user (authorized or unauthorized) performed or attempted to perform using the authentication device.

In one embodiment, audit files, thumbprints, and other data stored on or used by the authentication device are encoded cryptographically and hashed, providing a method to determine if data has been tampered with by anyone using or attempting to use the authentication device. In one embodiment, audit files on the authentication device are periodically compared with audit files on the server. These comparisons provide a means of verification and validation of the authentication device and its use.

In one embodiment, when coupled with the authentication servers, the authentication device can be activated, deactivated and cancelled (taken out of commission) remotely by using the authentication key management infrastructure. In one embodiment, the authentication device facilitates abuse detection in the system by verifying what is displayed on the user's computer screen, validating certain parts of the user's credentials, and having a point of comparison of audit files.

In one embodiment, the authentication servers discriminate authentication methods from authentication devices. In one embodiment, the authentication servers deploy new encryption algorithms and/or firmware upgrades to the authentication device.

In one embodiment, the authentication device and authentication servers form a trusted communication channel. When the authentication servers are provided to a Host data system, the trusted communication channel can be used for communication between the host data system and the user's computer. In one embodiment, messages for trusted computing are based on secure communication from the authentication servers to the authentication device, not from local applications running on the user's computer.

In one embodiment, the authentication servers handle storage and distribution used by authentication device users as they connect to the authentication servers. In one embodiment, the authentication servers are configured to rate and grade identification and authentication tokens and methods. In one embodiment, the authentication servers handle the receipt, decryption, storage, analysis, reporting, and notification related to the exportable audit file. In one embodiment, processes that store, validate, parse, distribute, and approve rights and authorities related to use of the authentication device run on the authentication servers. In one embodiment, data entered into the authentication device as part of a proof-of-presence process is validated on the authentication servers.

In one embodiment, a method for authenticating a user is disclosed. The method includes the steps of obtaining an indication of a biometric parameter using a secured computing device from a user, where the indication provides information on the identity of the user, verifying that the obtained indication of the biometric parameter substantially matches the stored indication of the biometric parameter, obtaining a first password from the user, verifying that the first password matches a stored second password, communicating the identity of the user to a remote host and requesting a salt value, receiving from the remote host said salt value and a remote host challenge value, calculating a device challenge value, calculating a hash using the salt value and first password, encrypting the remote host challenge value and the device challenge value using the hash, receiving an unencrypted device challenge value from the remote host, verifying that the received unencrypted device challenge value is identical to the calculated device challenge value, generating a session master secret, encrypting the session master secret, and communicating the session master secret to the remote host. In one embodiment, the method also includes initiating the communication between the secured device and the remote host using an unsecured device, where the communication path between the secured device and the remote host passes through the unsecured device and where the communications are not shared with the unsecured device. In one embodiment, the method includes the step of storing transaction information on the secured computing device. In one embodiment, the method also includes the steps of retrieving a stored hash at the remote host, decrypting the remote host challenge value and the device challenge value using the retrieved stored hash, determining whether the host challenge value and the device challenge value are identical, and transmitting the unencrypted device challenge value if the decrypted challenge value and device challenge value are identical.

In one embodiment, a method of providing authenticated and secure electronic communications over an unsecured electronic communication path is disclosed. The method includes the steps of providing a secured device including at least a biometric sensor, a user input, and a display, requesting a secure communication value from the secure network server over an unsecured communication path, receiving at the secured device the secure communication value, displaying on the display a message, authenticating a user's identity using the biometric sensor, encrypting a message using the secured device, and communicating the encrypted message over the unsecured communication path to the secured network server. In one embodiment, the secured device is configured to communicate with a secure network server. In one embodiment, the secured device is connectable to an unsecured computing platform. In one embodiment, the unsecured computing platform provides the unsecured network communication path. In one embodiment, the authentication and encryption device communicates with the secure network sever through the unsecured computing platform without sharing useful information with the unsecured computing platform. In one embodiment, the biometric sensor includes a finger or thumb print reader. In one embodiment, the user input includes a keypad. In one embodiment, the method includes the steps of calculating an authentication device challenge value and using a salt value to calculate a hash of the salt and receiving a user password entered via the input device to create an encryption key, and encrypting one or more challenge values using said encryption key, where said salt value is received from a remote host after said processor has verified said user using data from said biometric sensor.

In one embodiment, a device for providing secure communication through an unsecured system is disclosed. The system includes a processor that calculates an authentication device challenge value and use a salt value to calculate a hash of the salt and a user password entered via the input device to create an encryption key, said processor further configured to encrypt one or more challenge values using said encryption key, where said salt value is received from a remote host after said processor has verified said user using data from said biometric sensor, a display in communication with the processor, a biometric sensor in communication with the processor configured to obtain biometric information useful in identifying an individual, an input device in communication with the processor, and a computer interface configured to provide a communication path between am unsecured computing platform and the processor; where the processor is further configured to communicate with a remote host through the unsecured computing platfor, where the encryption key is not shared with the unsecured computing platform. In one embodiment, the system also includes a non-volatile memory, where said processor stores an audit file in said non-volatile memory. In one embodiment, the input device is a keypad. In one embodiment, the computer interface is a USB interface. In one embodiment, the system includes an internal power source, where said processor is configured to delete selected security data when said computer interface is disconnected from a computer.

In one embodiment, a system for authenticating a transaction is disclosed. The system includes an unsecured device configured to initiate a transaction with a secured remote host, a secure device connectable to the unsecured device which verifies a user's identity by obtaining a biometric indication. In one embodiment, the secure device is further configured to send and receive encrypted communications with the remote host. In one embodiment, the encrypted communications pass through the unsecured device without being unencrypted by the unsecured device. In one embodiment, the biometric indication is an indication of finger prints.

### BRIEF DESCRIPTION OF THE DRAWINGS

FIG. 1 illustrates a system for securing and authenticating transactions.

FIG. 2 illustrates a system for securing and authenticating transactions.

FIG. 3 illustrates a flowchart of a device initialization process.

FIG. 4 illustrates a flowchart of a device configuration process.

FIGS. 5A-5C illustrate a flowchart of a user setup process.

FIGS. 6A-6D illustrate a flowchart of a device login process.

FIG. 7A-7C illustrate a flowchart of a proof of presence process.

FIG. 8 illustrates a flowchart of a device logout process.

FIGS. 9A-9C illustrate a flowchart of a change password process.

FIG. 10 illustrates a flowchart of a device removal or power loss process.

FIG. 11 illustrates a flowchart of a driver setup process.

FIG. 12 illustrates a flowchart of a PC driver USB connect process.

FIG. 13 illustrates a flowchart of a PC driver USB disconnect process.

FIG. 14 illustrates a chain of authorization.

### DETAILED DESCRIPTION

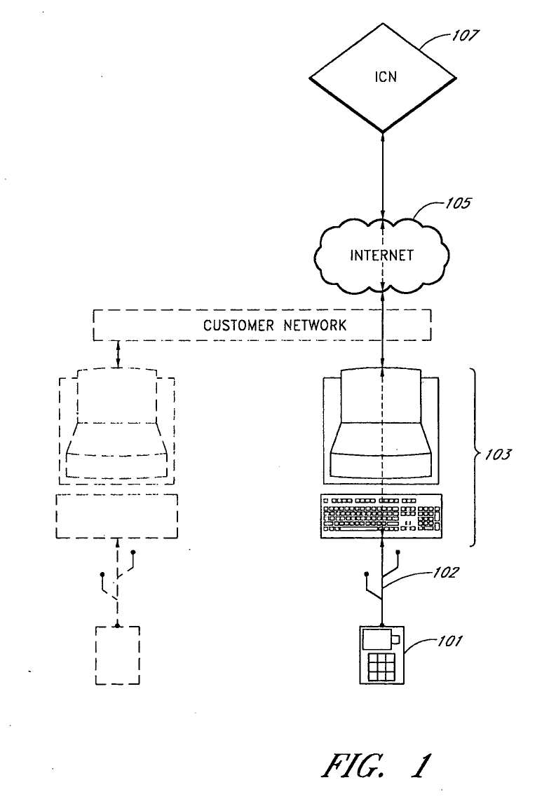

FIG. 1 illustrates a system for securing and authenticating transactions. A authentication device 101 is coupled with a computer 103. The computer 103 is connected to the Internet or other private or public network 105. An authentication servers 107, or remote host is also connected to the Internet 105. The computer 103 and authentication servers 107 can connect to the Internet wirelessly or through a cable. Likewise the authentication device 101 can connect to the computer 103 through wired or wireless means. In one embodiment, the authentication device 101 connects to the computer 103 through a USB cable connection, IEEE 1394 firewire connection or the like. In one embodiment, the authentication device 101 is an authentication device used to establish both a trusted computing base and a trusted communication path between a non-secure PC, such as computer 103 and the authentication 107 servers.

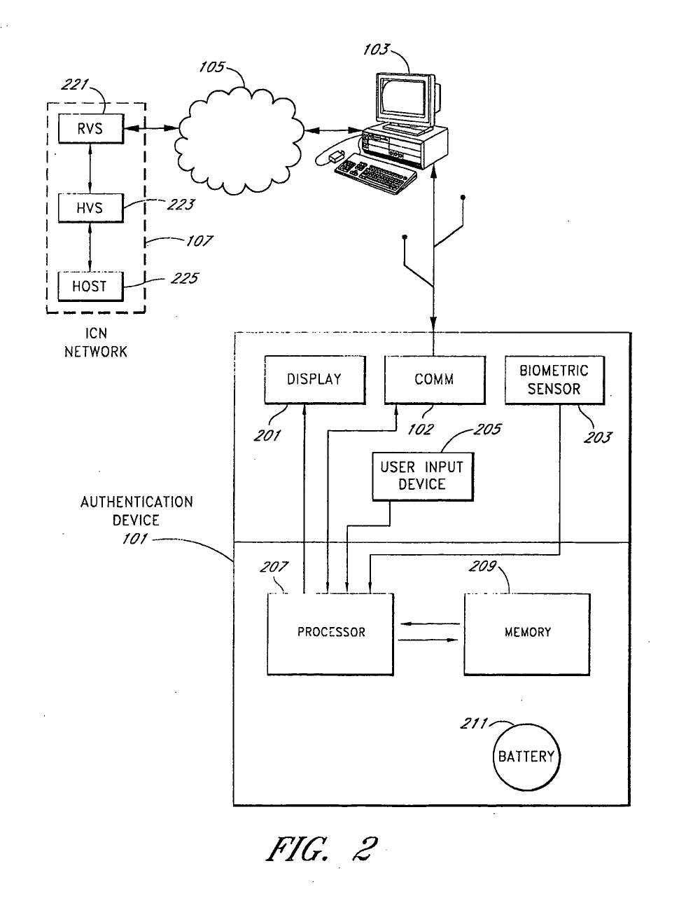

FIG. 2 also illustrates a system for securing and authenticating transactions. In one embodiment, the authentication device 101 includes a combination of one or more of the following hardware components: a display 201, such as, for example, an LCD or LED display; a user input device 205, such as a keypad, touch screen display interface or the like; a biometric sensor 203, such as a finger or thumbprint reader or retinal scanner or the like; a communication link 102 such as a USB cable, Ethernet, Bluetooth, or the like, including both hardwired and wireless communication; memory 209, including read only memory (ROM) and/or read/write memory (RAM) or the like; one or more processors 207; a case; and a battery 211. In one embodiment, the battery is a power supply as described below. In one embodiment, memory is volatile and/or non-volatile memory. The authentication device 101 can be used to authenticate and authorize user access; provide a login; provide proof of presence; provide a logout; change a password; and authenticate a device removal and/or power loss condition. In one embodiment, low power components are used to minimize electrical and magnetic emissions from the device 101. In one embodiment, the device 101 is shielded to prevent emission for electrical and magnetic emissions. In one embodiment, the device 101 is made from parts designed to break if tampered with.

Although certain embodiments herein are described as using a USB cable, a person of ordinary skill in the are will recognize that other forms of electronic communication can also be used, such as, for example, IEEE 1394 firewire, Bluetooth, Ethernet, etc. It is to be understood that descriptions in relation to a USB cable are by way of example, and not limitation.

In one embodiment, the authentication servers 107 includes a Remote Validation Server 221 (RVS), a Host Validation Server 223 (HVS), and a Host 225. A person of ordinary skill will understand that the functions performed by the authentication servers 107 can be performed by a single server or by multiple servers. Likewise a single processor and/or computing device or multiple processor and/or computing devices can be used to perform the functions of the authentication servers 107.

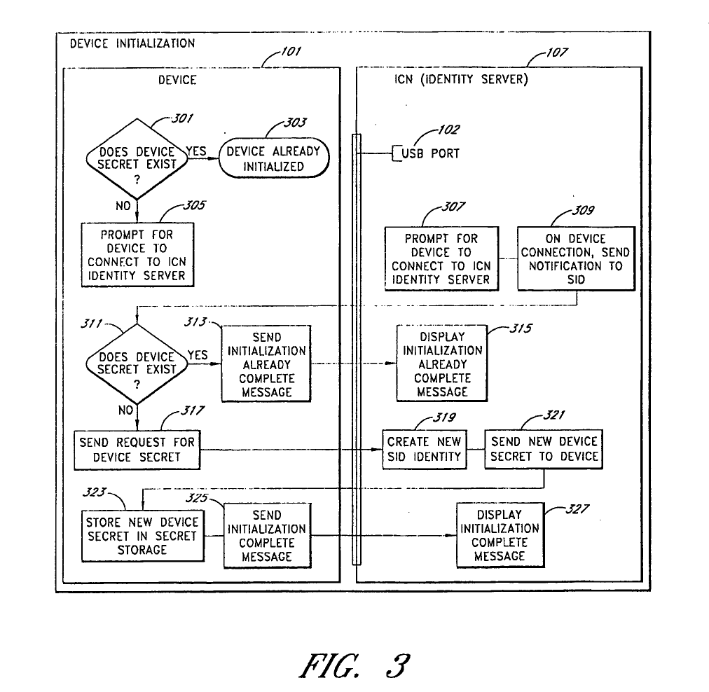

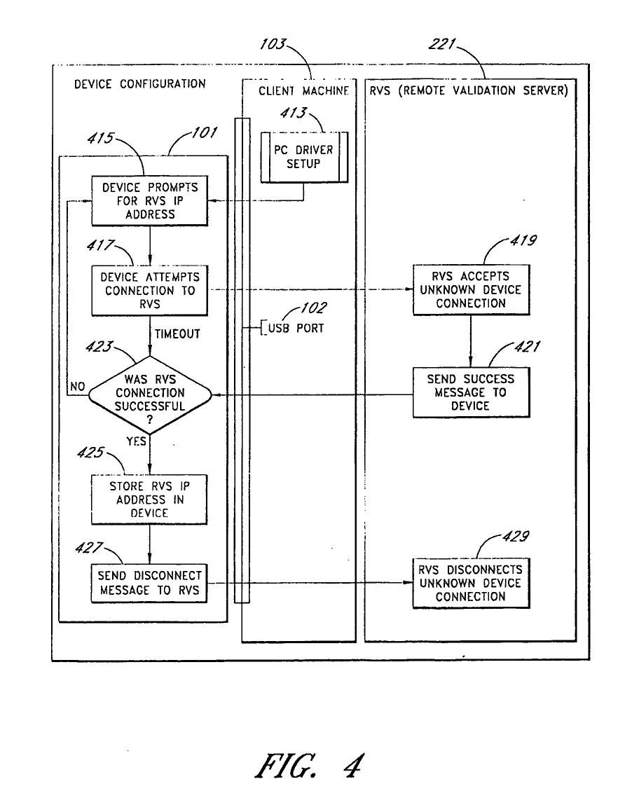

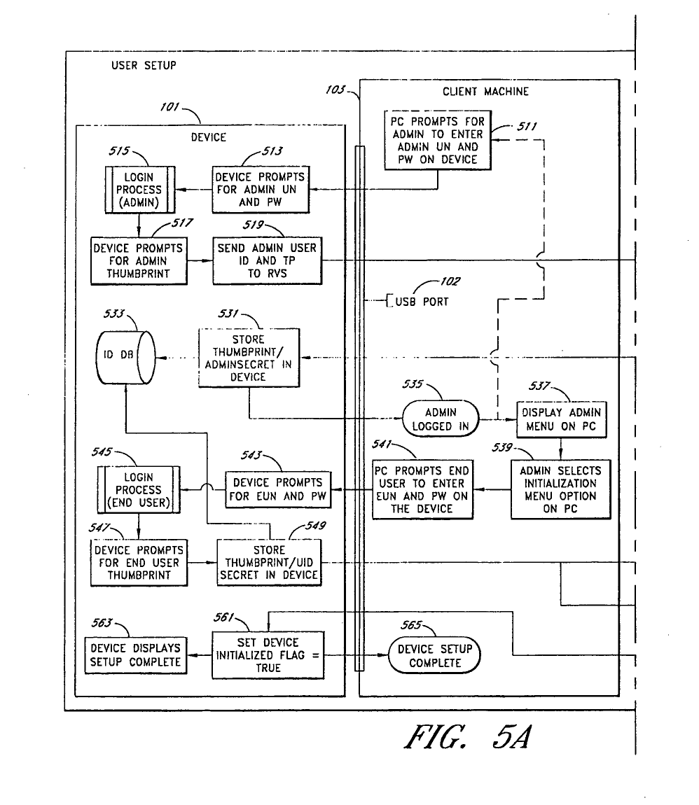

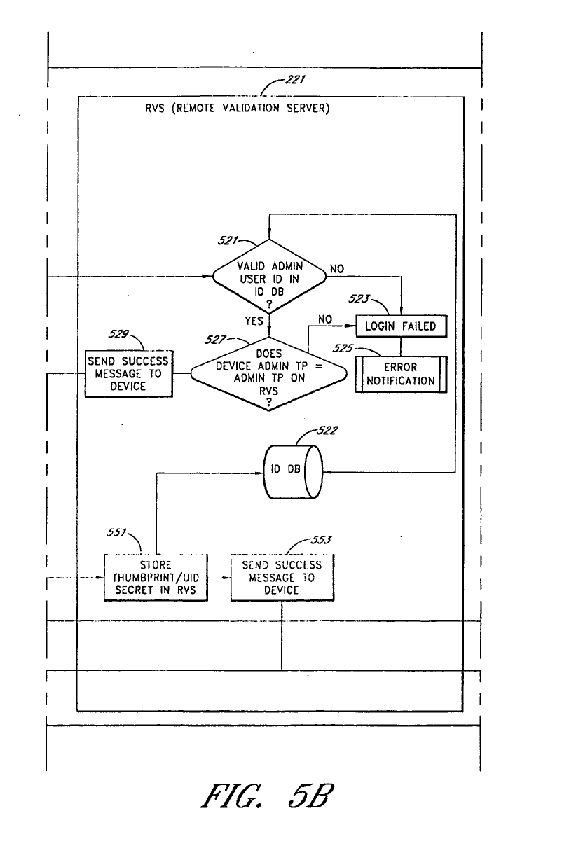

In one embodiment, the system is securely maintained by requiring authorized users to setup devices and authorize other users. Thus, each device must be uniquely initialized and programmed for each user of that device. To this end, a number of security protocol processes are used to maintain the trusted nature of the system. FIGS. 3-13 detail these security processes.

FIG. 3 illustrates a flowchart of a device initialization process. The device initialization process is a process for installing the secret identifier into the device secret storage. This secret identifier is generally provided by an authentication identity server, and is used to uniquely identify the device 101 to the authentication servers 107.

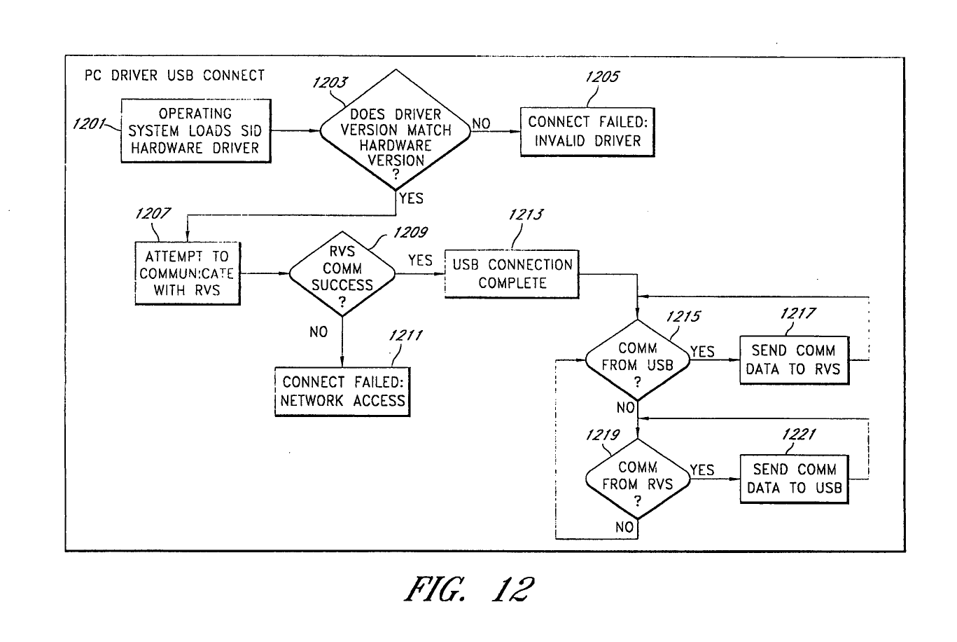

First, the authentication device 101 must determine if the secret identifier exists within the device secret storage at block 301. If it does exist, then the authentication device 101 is already initialized at block 303, and this process is generally unavailable for execution. Otherwise, the authentication device 101 prompts the user to connect the device to the authentication identity server at block 305. The authentication identity server 107 prompts for the device USB connection at block 307 (e.g. see FIG. 12). Once the USB connection is validated, the authentication identity server 107 sends a notification of connection to the authentication device 101 at block 309.

The device 101 again performs the search for the secret identifier within the device secret storage at block 311. If the secret identifier already exist, then the device initialization is already complete, the device notifies the authentication identity server 107. The authentication identity server 107 displays this status and exits at block 315. If the secret identifier does not already exist at block 311, then the device sends a request to the authentication identity server for the new device secret identifier at block 317.

Once the authentication identity server receives the request for a new device secret identifier, it creates the new secret identifier within directory services at block 319 and sends the identifier to the device at block 321. The device 101 then stores the new secret identifier in secret storage at block 323. Once the storage is complete, the device sends a completion success message to the authentication identity server 107 and disconnects at block 725. The authentication identity server 107 displays the completion message and exits as well at block 327.

FIG. 4 illustrates a flowchart of a device configuration process. The device configuration process is used to configure the device 101 for use on a customer network and/or allow the device an user to be authenticated by the authentication server 107. The device 101 will then be set up to use the RVS 221. In one embodiment, separate RVSs are provided for each customer. In one embodiment, one or more RVSs are shared among multiple customers. In one embodiment, the device configuration process begins at block 413 where the PC driver is setup. Once the device 101 is connected to the PC via the USB connector or other connecting device, the device 101 prompts the user to enter the IP address of the RVS 221 assigned to that customer at block 415. The device 101 then attempts to connect to the RVS 221 at block 417. If the device 101 is successful in communicating with the RVS 221, then the RVS 221 accepts the connection from the unknown device at block 419. The RVS 221 then sends a reply message validating that the device 101 connected successfully to the RVS 221 at block 421.

If no message is returned from the RVS 221 before a timeout is reached at block 417, the device 101 will again prompt for the IP address of the RVS 221 at block 415 and attempt the connection again at block 417. If the device 101 does receive a reply from the RVS 221, then the device 101 will permanently store the IP address of the RVS 221 at block 425 and send a disconnect message to the RVS 221 at block 427. The RVS 221 will also sever the connection at block 429.

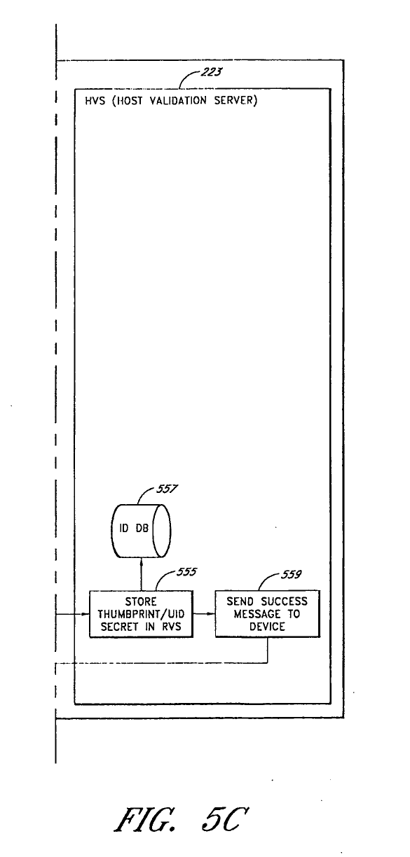

FIGS. 5A-5C illustrate a flowchart of a user setup process. In one embodiment, the setup process is used when a new or un-initialized authentication device is provided to a computer 103 (e.g., a personal computer, data terminal, etc., herein referred to simply as a “PC” or “computer” in the text and as the “Client Machine” in FIGS. 3-13) and assigned to a user. In one embodiment, an authorized representative of the authentication servers 107 sets up a valid first administrator (e.g. in connection with an organization, company, customer, etc.). The valid administrator is authorized to setup other administrators (e.g., see FIG. 14) The administrators are also authorized to setup end users. In one embodiment, at least two valid administrators are required to setup an end user. The administrator performs a “Create New User” process, on the authentication server system to register the new user with the authentication servers before setting up the authentication device. In one embodiment, at least two administrators are required to perform a “Create New Use” process, thus preventing collusion and fraud.

The user setup or “Create New User” process begins at block 511 where the PC displays a message prompting the administrator to enter a valid administrator username and password on the authentication device 101. The device also displays a message prompting the administrator to enter a valid administrator username and password on the authentication device 101 at block 513. After a correct administration username and password are entered, the administrator is logged into the ICN Network 107 at block 515. The authentication device 101 then prompts for the administrator's thumbprint at block 517. At block 519, the device 101 sends the administrators thumbprint and identification (including at least one of a user name and password) to the RVS for validation against the administrator's stored identification at block 521 and stored thumbprint at block 527. If the identification at block 521 or thumbprints at block 527 do not match the stored identification or thumbprints, the administrator is logged out at block 523 and the error notification process is initiated at block 525. If the identification and thumbprints match, the RVS 221 sends a message to the authentication device at block 529 signifying that it is okay for the authentication device 101 to store the administrator's thumbprint in its internal ID database. The device 101 then stores the administrators thumbprint and ID at block 531 in the ID database 533. Once the administrator's thumbprint is stored, the authentication device 101 signals to the ICN 107 that the administrator is logged in at block 535. In one embodiment, this process is repeated for each administrator required to setup an end user if multiple administrators are required.

Once the administrator is logged in, the ICN 107 provides an administrator menu at block 537. The administrator then selects the authentication device initialization option from the administrator menu at block 539. Once this option is selected, the ICN 107 software displays a message on the PC for the user to enter his/her user ID and password on the authentication device at block 541. The authentication device 101 also prompts for these values at block 543. When they are entered, the authentication device 101 attempts to log the user into the ICN 107 servers at block 545. Once the login process is complete, the authentication device prompts for the user's thumbprint at block 547. The thumbprint is stored in the authentication device's ID database 533 at block 549. After the user's thumbprint is stored, the authentication device 101 sends the user ID and thumbprint to the RVS 221 and the HVS 223.

Both the RVS 221 and the HVS 223 store the thumbprint of the user ID in their respective ID databases 522, 557 at blocks 551 and 559. After successfully storing the user ID and thumbprint, the RVS 221 and HVS 223 signal a successful initialization message to the authentication device 101 at blocks 553 and 559. The authentication device 101 then sets its internal “Initialized” flag to “True” at block 561. The device 101 then displays a successful setup message at block 563, and sends a message to the PC 103 at block 565 and ICN 107 to do likewise.

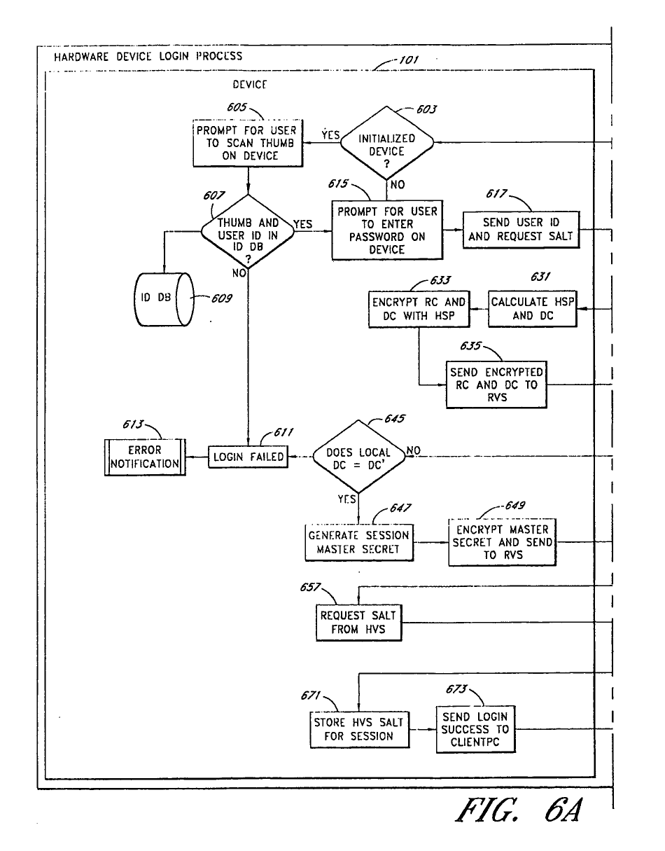

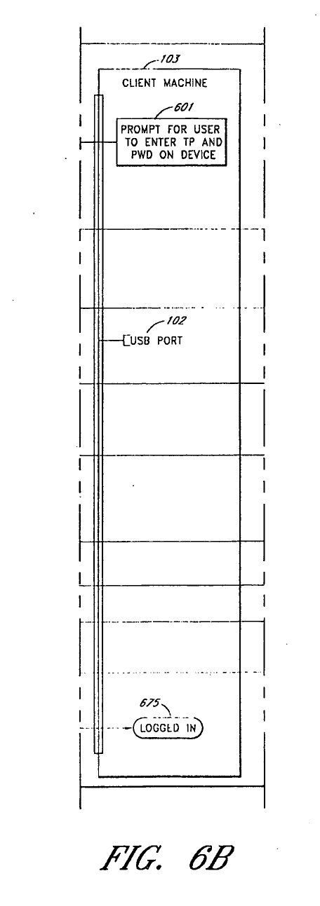

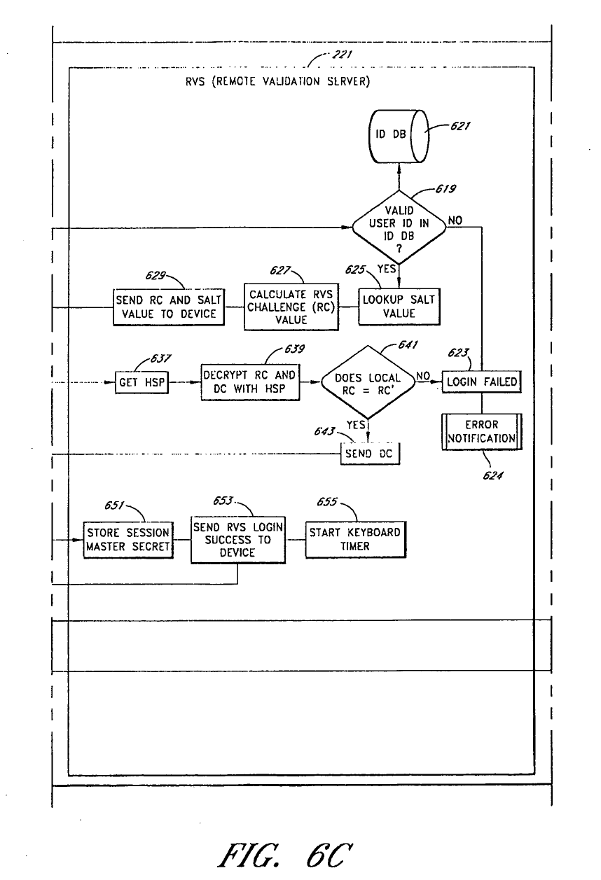

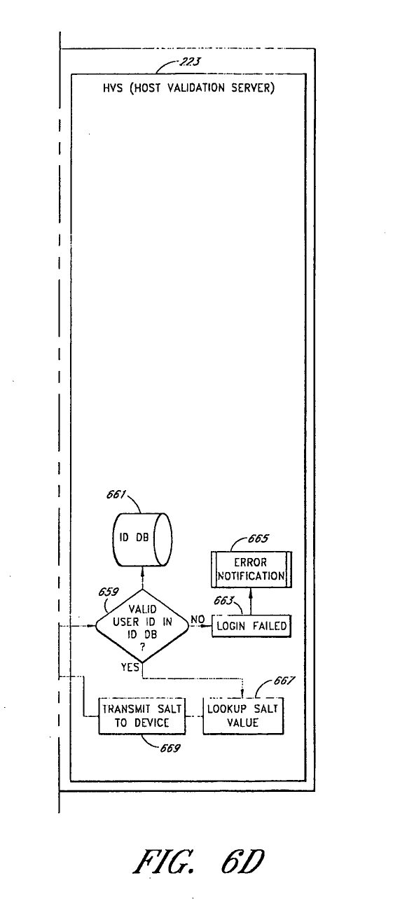

FIGS. 6A-6D illustrate a flowchart of a device login process. The Login process is used when a user wants to log into the ICN Network 107 (e.g., access the host). The use of the authentication device in addition to the ICN 107 software provides a Trusted Computing Base and Trusted Path between the authentication device and the ICN Servers.

The Login process is initiated by the ICN 107 software, which prompts the user to provide their thumbprint and password on the authentication device 101 at block 601. The authentication device 101 then determines if its internal “Initialized” flag is set to “true” at block 603. If it is, the authentication device prompts for the user's thumbprint at block 605. Otherwise, the thumbprint section of the login process is skipped and the user is prompted for their user ID and/or password at block 615.

If the user is prompted for and provides a thumbprint at block 605, it is used to find the User ID within the Authentication Device ID database 609 at block 607. If the thumbprint does not exist in the ID database, the process ends with an error at block 61 and 613. Otherwise, the user is prompted for his/her password at block 615.

Once the password is provided, the authentication device 101 sends the user ID to the RVS 221 and requests a salt value from the RVS 221 at block 617. The RVS 221 determines if the user ID exists in the RVS ID database and whether the user ID is valid at block 619 using ID database 621. If the user ID is not valid the process ends and the system initializes the error notification process at blocks 623 and 624.

If the user ID is valid, a salt value for that user is retrieved from the RVS ID database 621 at block 625. An RVS challenge value is calculated at block 627 and the salt and RVS challenge values are sent to the authentication device at block 629.

The authentication device calculates an authentication device challenge value and uses the salt value to calculate a Hash of the Salt and Password (HSP) at block 631. The device 101 encrypts both the RVS challenge and the authentication device challenge values using the HSP at block 633, and sends them both to the RVS 221 at block 635.

The RVS retrieves the HSP that is stored in the RVS ID database 621 for the user at block 637, and uses it to decrypt the RVS challenge and authentication device challenge values sent from the authentication device at block 639. The RVS tests whether the decrypted RVS challenge value is equal to the RVS challenge value it created itself at block 641. If the values are not identical, the process ends and the system initializes the error notification process at blocks 623 and 624. Otherwise, the unencrypted authentication device challenge value is sent back to the authentication device 101 for verification at block 643.

The authentication device 101 compares the unencrypted authentication device challenge to see if it is equal to the original authentication device challenge value at block 645. If the values are not identical, the process ends and the system initializes the error notification process at blocks 611 and 613. Otherwise, a session master secret is created at block 647. The session master secret is then encrypted and sent to the RVS 221 at block 649. The RVS 221 decrypts and stores the session master secret for the duration of the current session at block 651. The RVS 221 then sends a login success message back to the authentication device 101 at block 653, and starts a keyboard timer at block 655. The session master secret is the key used to encrypt and decrypt communications between the authentication device 101 and the authentication servers 107.

Upon receipt of the RVS login success message, the authentication device 101 sends a request to the HVS 225 to retrieve a salt value at block 657. The HVS 225 again validates the user ID against its internal ID database 661 at block 659. If the user ID is not found on the ID database 661, then the HVS 223 begins the error notification process at blocks 663 and 665. Otherwise, the HVS 223 looks up the salt value for that user ID at block 667. The HVS 225 then sends the salt value back to the authentication device at block 669. The authentication device 101 stores the HVS salt value for the duration of the session at block 671, and sends a login successful message to PC 103 at block 673. The PC 103 displays a login successful message to the user.

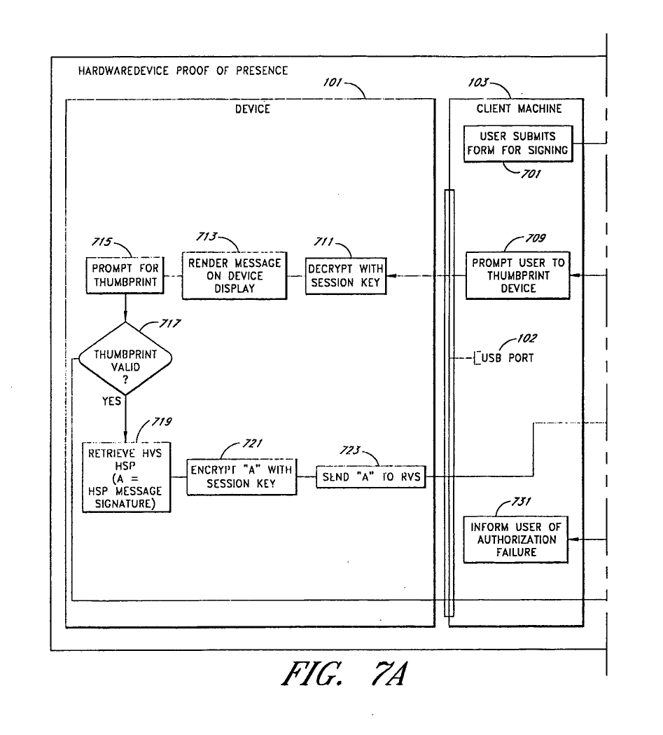

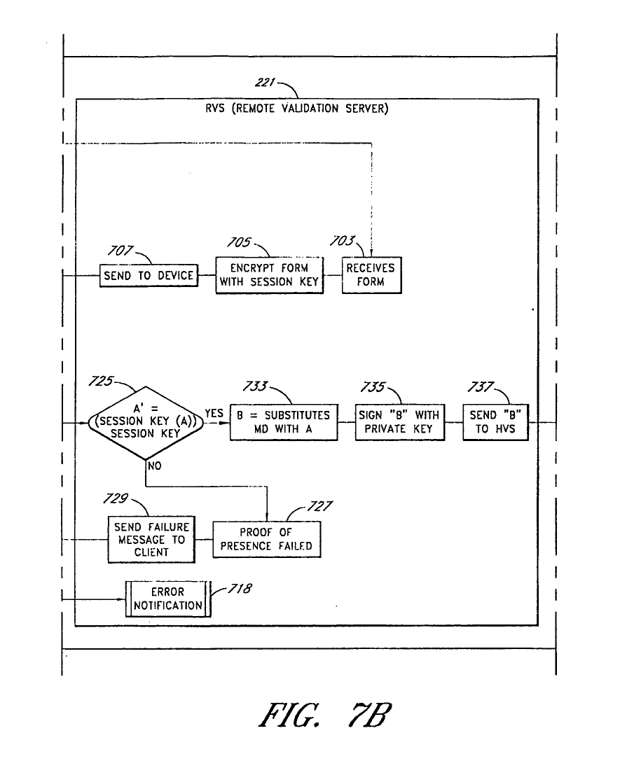

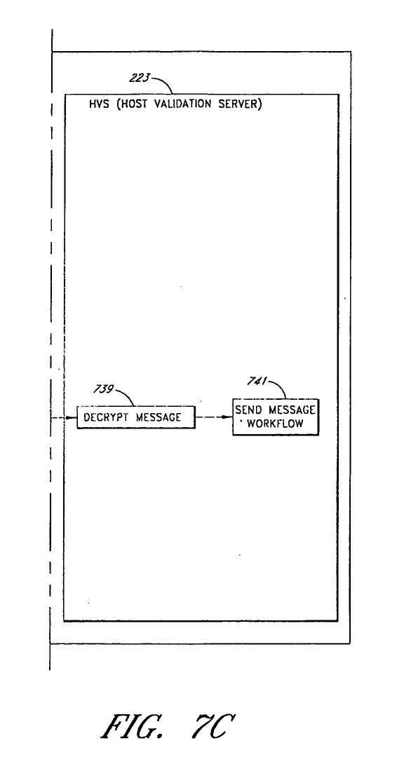

FIGS. 7A-7C illustrate a flowchart of a device proof of presence process. The proof of presence process is used to prove that a user is actually present at the PC 103 when a secure message is sent from the PC 103 to the ICN Network 107. A user generally logs in before beginning the proof of presence process.

The proof of presence process starts when the user submits a screen form for signing at block 701. This form data is sent to the RVS 221 from the PC 103. The RVS 221 receives the form at block 703. The RVS 221 then encrypts the form or information obtained from the form data with the current session key at block 705 and sends it to the authentication device 101 via the ICN 107 at block 707. The PC 103 displays a message directing the user to provide a thumbprint on the authentication device 101 at block 709. The authentication device 101 receives the encrypted form data and decrypts it at block 711. The device 101 displays some or all of the data on the authentication device display at block 713. If the data displayed on the authentication device matches the data the user submitted on the ICN 107 form, the authentication device prompts the user to provide their thumbprint at block 715. If the action is cancelled because the data is not correct, or the thumbprint is not valid at block 717, the system initializes the error notification process at block 718.

If a valid thumbprint was provided at block 717, a signature is created for the form data at block 719. This device 101 retrieves the HVS 223 HSP at block 719. The HSP is again encrypted with the current session key at block 721, as described below. This encrypted value is sent to the RVS 211 at block 723.

The RVS 221 then decrypts the message with the session key and compares it against the original content at block 725. If the content does not match, the proof of presence process has failed at block 727, and the system sends a failure message to the client at block 729. The PC 103 displays a message at block 731 informing the user of the authorization failure. Otherwise, a new message digest is created for the network transmission of the data from the RVS 221 to the HVS 223 at block 733. The message is encrypted at block 735 and sent to the HVS 223 at block 737. The HVS 223 then decrypts the message at block 739, checks the message digest to ensure the message was sent from the RVS 221, and sends the transaction on to the workflow engine at block 741.

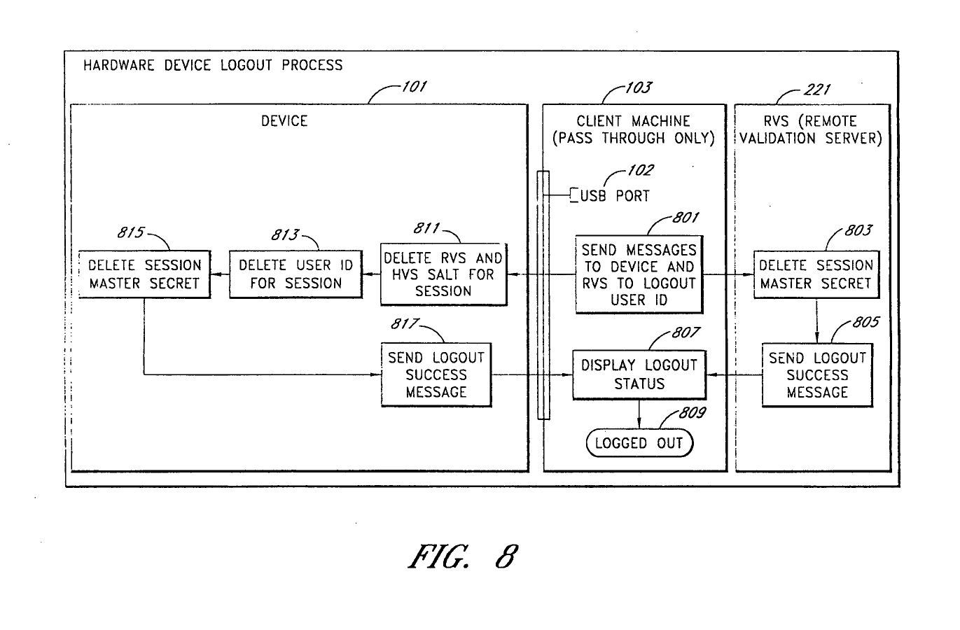

FIG. 8 illustrates a flowchart of a logout process. The Logout process is started by the user selecting a logout option from the PC 103. The PC 103 sends messages to both the RVS 221 and the authentication device 101, telling them to logout the current user ID at block 801.

The RVS 221 removes from memory the session master secret and all other data associated with the current user ID session at block 803. The RVS 221 sends a logout successful message back to the PC 103 at block 805.

The authentication device 101 removes from memory the salt values from both the RVS and the HVS at block 811, the user ID at block 813, the session master secret at lbock 815, and other secure communication data associated with the current user ID session. The authentication device sends a logout successful message back to the PC 103.

The PC 103 displays the logout status by reporting the logout successful messages from both the authentication device 101 and the RVS 221 at block 807. Once both messages are received, the user is logged out at block 809.

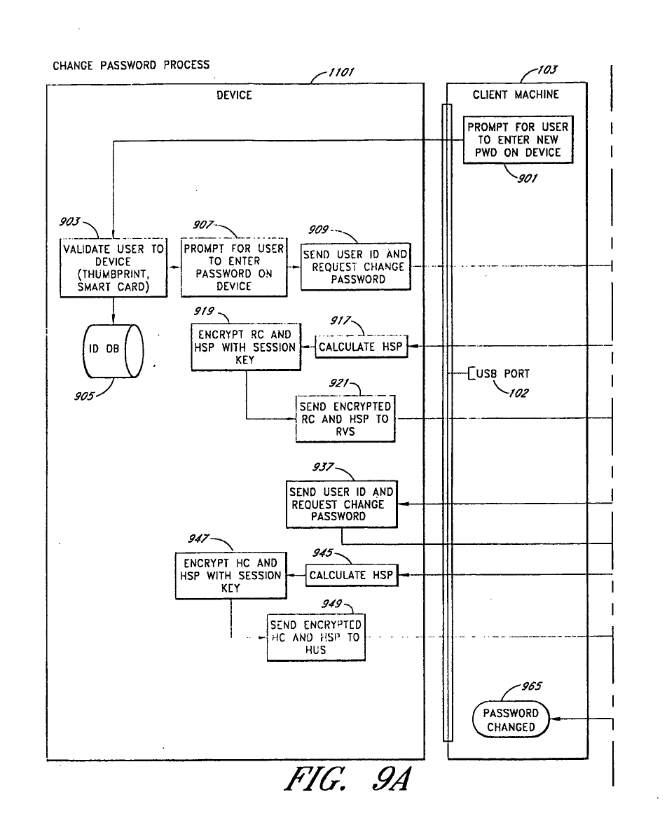

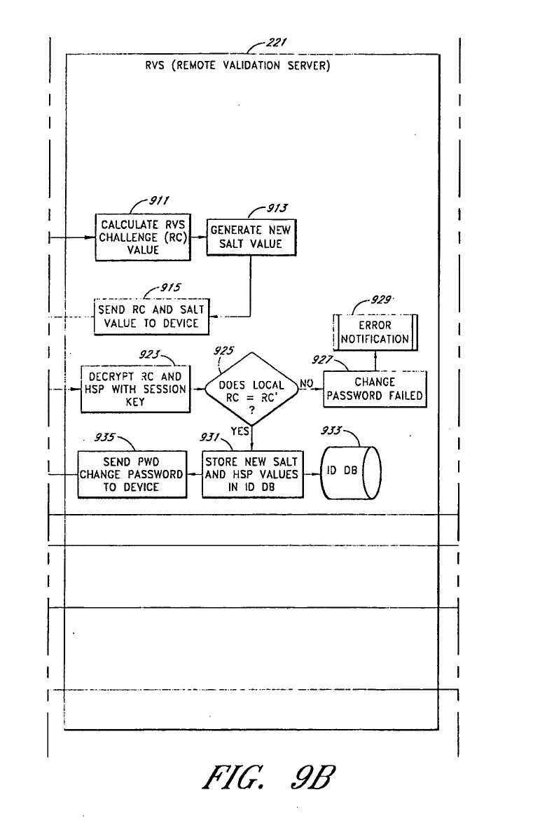

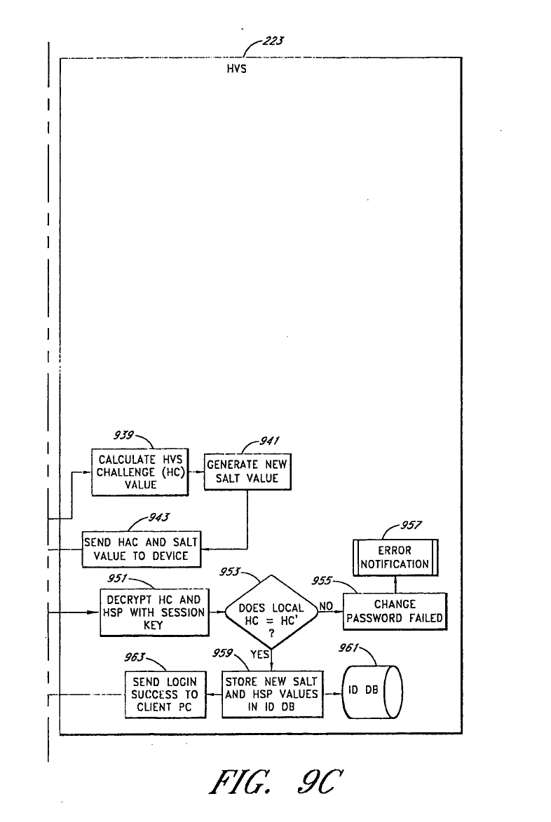

FIGS. 9A-9C illustrate a flowchart of a change password process. The first time a user logs into the ICN Network 107, this process is triggered.

The process starts when the PC 103 displays a message prompting the user to enter a new password in the authentication device 101 at block 901. The authentication device 101 prompts the user to provide a thumbprint or smartcard for validation at block 903 using information stored in the ID database 905. The device 101 then prompts for the new password at block 907. Once the password is provided, the user ID is sent to the RVS 221 in a message requesting a password change at block 909.

The RVS 221 calculates the RVS challenge value at block 911 and generates a new salt value for the user ID at block 913. The RVS 221 then sends the challenge and salt values to the authentication device 101 at block 915. The authentication device calculates the HSP at block 917, encrypts the HSP with the session key at block 919, and sends this back to the RVS 221 at block 921.

The RVS decrypts the HSP using the session key at block 923, and checks that the decrypted challenge value is identical to the original challenge value at block 925. If the values are not identical, the system initiates the error notification process at blocks 927 and 929. Otherwise, the RVS 221 stores the new salt and HSP values in the RVS ID database 933 at block 931 and sends a change password successful message back to the authentication device at block 937.

The authentication device 101 then sends the user ID to the HVS 223 in a message requesting a password change at block 937. The HVS 223 calculates the HVS challenge value at block 939, generates a new salt value for the user ID at block 941, and sends the challenge and salt values to the authentication device 101 at block 943. The authentication device 101 calculates the HSP at block 945, encrypts the HSP with the session key at block 947, and sends it back to the HVS 223 at block 949.

The HVS 223 decrypts the challenge value and HSP using the session key at block 951 and checks that the decrypted challenge value is identical to the original challenge value at block 953. If the values are not identical, the system initializes the error notification process at blocks 955 and 957. Otherwise, the HVS 223 stores the new salt and HSP values in the HVS ID database 961 at block 959 and sends a change password successful message to the authentication device 101 and the PC 103 at block 963. The PC displays a change password message at block 965.

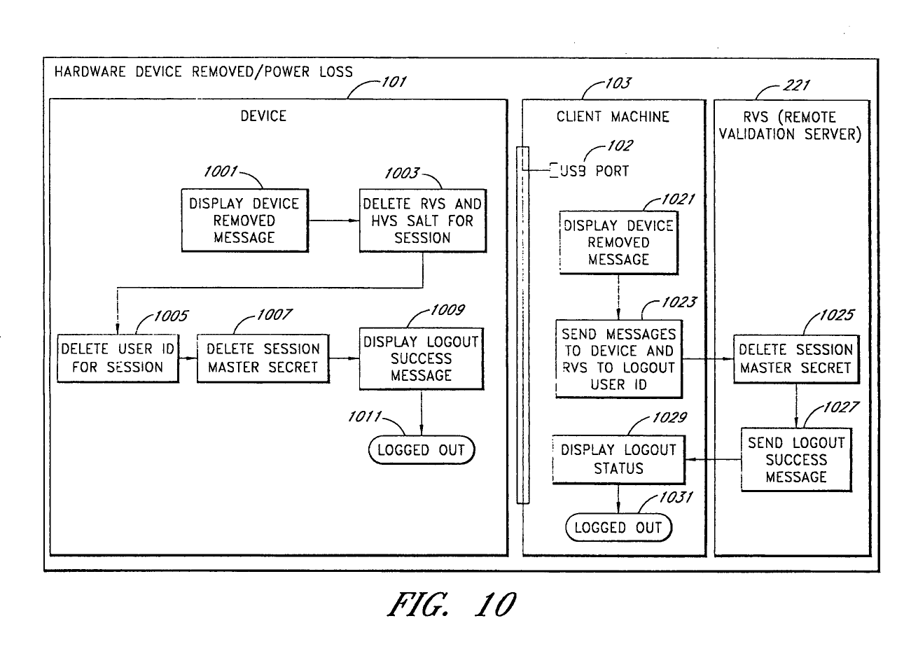

FIG. 10 illustrates a flowchart of a device removed/power loss process. The authentication device removal/power loss process is started when the authentication device is removed from the PC 107 such as, for example if the USB or other connection is terminated or unplugged from the USB port, or when the USB power supply is lost such as by a PC 103 shut down or loss of power to the PC 103.

In one embodiment, the authentication device has an internal power source (e.g., a battery, rechargeable battery, capacitor, etc.) which allows it to continue to operate for a period of time to complete this process. The authentication device 101 displays a message at block 1001 signifying that the authentication device has been removed from the PC 103 or that power from the PC 103 has been lost, which can occur, for example, when the PC is shut down or loses power. The authentication device 1001 then deletes the RVS and HVS salt values stored for the current session at block 1003. The authentication device also deletes the user ID at block 1005 and the session master secret at block 1007. The device 101 then displays a removal success message at block 1009 before powering down at block 1011. In one embodiment, each of these steps is accompanied by time-stamped audit log entries for later auditing. In one embodiment, the audit log and other history information stored on the authorization device is stored in non-volatile memory.

If the PC 103 is still executing when the authentication device 101 is removed (i.e., power is not lost), the PC 103 will display a message signifying that the authentication device 101 has been removed from the PC 103 at block 1021. The PC 103 then sends a message to the device 101 and RVS 221 to perform a disconnected logout process for the user ID at block 1023. This logout process consists of the RVS 221 deleting the user ID and session master secret at block 1025 and sending a disconnected logout success message back to the PC 103 at block 1027. The PC 103 displays a logout status message at block 1029, and the user is logged out of the ICN system at block 1031.

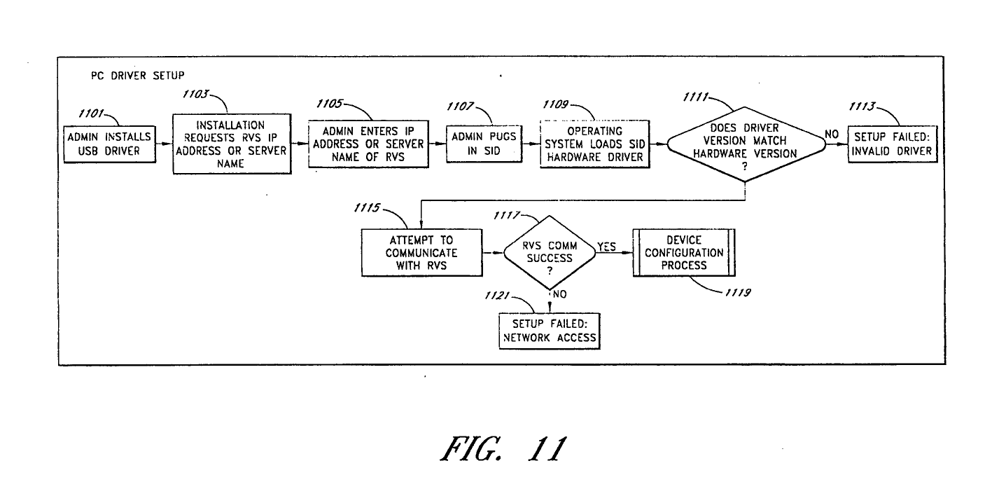

FIG. 11 illustrates a flowchart of a PC driver setup process. The PC driver setup process is initiated when an administrator or user at a customer location starts the device driver software installation on a customer PC. If the device 101 is connected to a PC 103 without first completing this process, then the device will not power on or be usable. 3

The first step in the process is to start the software installation, which is a standard PC installation executable at block 1101. Once the software has been copied onto the PC 103 and properly registered with the operating system, the software will then prompt the administrator for the IP address or server name of the RVS 221 associated with the customer at block 1103. The administrator then enter the requested information at block 1105.

The installation executable then requests for the administrator connect the device 101 to the PC 103 at block 1107. At this point, the operating system detects the device type and loads the appropriate hardware driver at block 1109. The driver then requests the hardware version of the device, and compares that value with an internal list of supported hardware versions at block 1111. If the versions do not match, then an error is thrown in the installation executable and the setup is aborted at block 1113. Otherwise, the driver will attempt to communicate directly to with the RVS 221 at block 1115. If it does not receive an answer from the RVS 221 within a short timeout period at block 1117, then an error is thrown in the installation executable and the setup is aborted at block 1121. If the driver does communicate with the RVS 221 at block 1117, then the installation is complete successfully and the device setup process initiates the device itself at block 1119.

FIG. 12 illustrates a flowchart of a PC driver USB connect process. Although described in relation to a USB connect process, a person of ordinary skill in the art will understand that any form of electrical device to device communication can be used between the device 101 and the PC 103, such as, for example, IEEE 1394 firewire or Bluetooth communication, and is not limited to a USB connection.

The PC driver USB connect process is generally initiated when the device is plugged into a USB port on the PC. When the device is plugged into a USB port on the PC 103, the operating system detects the USB authentication device type and loads the appropriate hardware driver at block 1201. The driver requests the hardware version of the device and compares that value with an internal list of supported hardware versions at block 1203. If the versions do not match, then an error is displayed on the PC 103 indicating that the device driver is not correct at block 1205.

If the hardware version does match, the driver will attempt to communicate directly to the RVS 221 at block 1207. If the driver does not receive an answer from the RVS 221 within a short timeout period at block 1209, then an error is displayed on the device and the PC indicating that network access failed at block 1211. If the driver successfully communicates with the RVS 221, the USB connection is complete at block 1213 and the driver enters a loop where it waits for communication to take place. If a data communication is received via USB at block 1215, the identical data is sent directly to the RVS 221 at block 1217, and the device waits in the same loop for more communication. If a data communication is received via network from the RVS 221 at block 1219, the identical data is sent directly to the device via USB at block 1221, and the device waits in the same loop for more communication. This process continues until the PC driver USB disconnect process in initiated as described below.

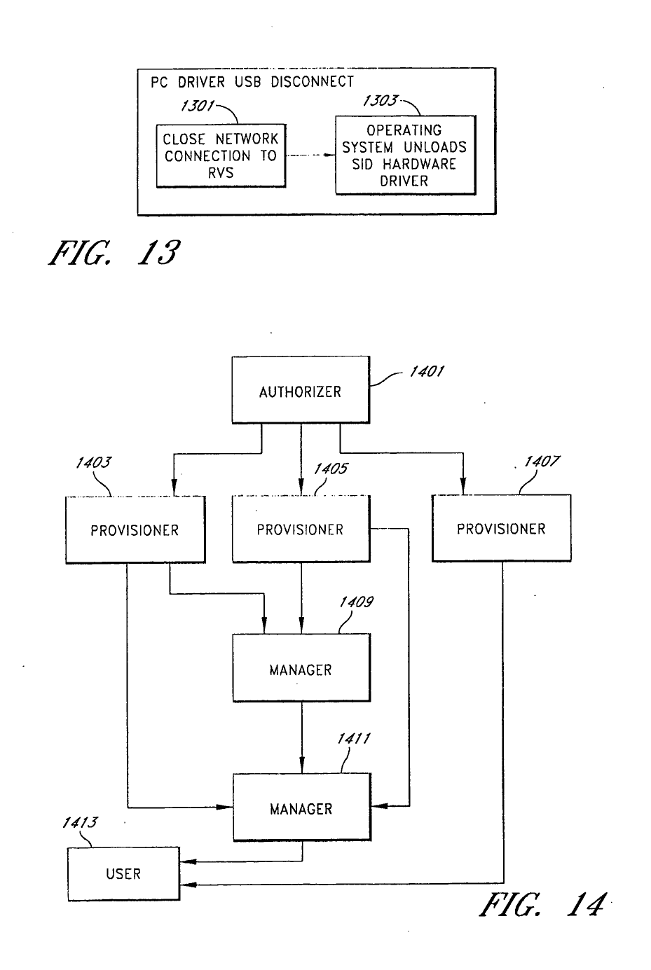

FIG. 13 illustrates a flowchart of a PC driver USB disconnect process. The PC driver USB disconnect process is initiated when the device 101 is unplugged from the USB port on the PC 103. It closes the network connection between the device 101 and the RVS 103 at block 1301. Once the network connection is closed, the driver signifies to the operating system to unload the device driver at block 1303.

FIG. 14 illustrates a chain of authorization. In one embodiment, organization supplied information and externally gathered information is used to verify the identity and key employees of an organization. An authorizer 1401 must initially authorize provisioners 1403, 1405, 1407. The provisioners 1403, 1405, 1407 can then authorize managers 1409, and 1411. A manager 1409, 1411 can then authorize a user 1413. In this way, the end user receives its authority through known and trusted sources such that the end user is also considered a trusted and authorized source. In one embodiment, multiple authorizers and/or provisioners and/or managers must authorize other authorizers and/or provisioners and/or managers and/or end users.

Referring to FIGS. 1-14, in one embodiment, the authentication device is used in connection with an authentication process to provide multi-level access controls and authorization controls. In one embodiment, inherent in the design of the device is the generation of secret/public key pairs. These key pairs, in combination with a trusted remote host and protected key management, prevent the device from being cloned or the key pairs from being replicated by others. Via the trusted remote host and key management, the public key is combined into independently-verifiable public key certificates, which generally only “fail securely” if altered after they are released to the public directory service. In addition, the device capabilities are instantly revocable by removing the directory service public key certificate. In one embodiment, the authentication device provides modular encryption. In one embodiment, a portable audit file provides audit and forensic capabilities. In one embodiment, the authentication device is used in connection with an evaluatable infrastructure. This creates a trusted computing base with one-way communication and a trusted path between the trusted computing base and the one or more authentication servers.

In one embodiment, the authentication device is configured as a computer peripheral device that can be connected to a user's computer and used to establish both a Trusted Computing Base and a Trusted Path between a non-secure user computer and the authentication servers. The authentication servers provide a relatively high level of security to ensure that transactions are secure and insurable. Using the authentication device along with the authentication servers and following established security procedures provides relatively high assurance to the user that communication between the user's computer and the authentication servers is authenticated and secure. In one embodiment, the system provides a three factor authentication including: a unique biometric identification, such as for example a thumbprint, fingerprint, or retinal scanner, etc.; a unique device identification; and a secret code (such as a password, pass code, etc.). (See e.g. FIGS. 1 and 6). In one embodiment, the device can capture an electronic signature either from the display or from an electronic signature pad.

In one embodiment, the authentication device, see e.g. FIG. 1, is provided to the user's computer (e.g., a personal computer, data terminal, etc.) using computer peripheral connection such as, for example, a USB connection, an IEEE 1394 firewire connection, Bluetooth, or the like, see FIG. 1. The user's computer passes encrypted communication between the authentication device and the authentication servers. The contents of the pass-through data cannot be decrypted or seen by the user's computer. The authentication device provides a desired level of security and authentication by using one or more of: authentication capabilities, monitoring capabilities, data confirmation, auditing capabilities, out-of-band communication, forensics, ability to track data tampering, and/or detect abuse.

In the secure communication environment, the authentication device receives incoming secure (e.g., encrypted) messages before they are routed to a software client on the user's computer. This creates a secure communication path between the authentication servers and the authentication device. This secure communication facilitates the establishment of a trusted path between the authentication servers and the authentication device. (See e.g. FIGS. 3-13). The messages can include text or graphics of any length.

In one embodiment, the authentication device interacts with the authentication servers to provide a key management infrastructure. Each authentication device is given a distinct digital private key. Firmware that runs on the authentication device is signed by a digital private key located in the key management infrastructure. In addition, the authentication device cannot be activated or deactivated without interaction with the key management infrastructure, where tokens for activation, deactivation, and canceling of the authentication device are stored.

In one embodiment, an authorized person can inspect and compare an on-board audit file stored in the authentication device to normalized patterns and/or to an audit file maintained by one or more of the authentication servers or the host system. In one embodiment, the audit files are maintained in non-volatile memory.

In one embodiment, the authentication device allows the user or security personnel to inspect in parallel the transaction information on the user's computer screen with the information on the authentication device screen in real-time.

In one embodiment, the authentication device creates its own independent audit file of actions performed on the authentication device. This file can be uploaded to the server, but is independent from the audit files created by the servers.

In one embodiment, communication between the authentication device and the authentication servers is encrypted and the user's computer is only “allowed” to “see” or have access to a limited amount of pre-determined data.

In one embodiment, authorized personnel can inspect the on-board audit file for the authentication device to determine what actions a user (authorized or unauthorized) performed or attempted to perform using the authentication device.

In one embodiment, audit files, thumbprints, and other data stored on or used by the authentication device are encoded cryptographically and hashed, providing a method to determine if data has been tampered with by anyone using or attempting to use the authentication device. In one embodiment, audit files on the authentication device are periodically compared with audit files on the server. These comparisons provide a means of verification and validation of the authentication device and its use.

In one embodiment, when coupled with the authentication servers, the authentication device can be activated, deactivated and cancelled (taken out of commission) remotely by using the authentication key management infrastructure. In one embodiment, the authentication device facilitates abuse detection in the system by verifying what is displayed on the user's computer screen, validating certain parts of the user's credentials, and having a point of comparison of audit files.

In one embodiment, the authentication servers discriminate authentication methods from authentication devices. In one embodiment, the authentication servers deploy new encryption algorithms and/or firmware upgrades to the authentication device.

In one embodiment, the authentication device and authentication servers form a trusted communication channel. When the authentication servers are provided to a Host data system, the trusted communication channel can be used for communication between the host data system and the user's computer. In one embodiment, messages for trusted computing base are based on secure communication from the authentication servers to the authentication device, not from local applications running on the user's computer. (See e.g. FIGS. 3-13)

In one embodiment, the authentication servers handle storage and distribution used by authentication device users as they connect to the authentication servers. In one embodiment, the authentication servers are configured to rate and grade identification and authentication tokens and methods. In one embodiment, the authentication servers handle the receipt, decryption, storage, analysis, reporting, and notification related to the exportable audit file. In one embodiment, processes that store, validate, parse, distribute, and approve rights and authorities related to use of the authentication device run on the authentication servers. In one embodiment, data entered into the authentication device as part of a proof-of-presence process is validated on the authentication servers.

Although the foregoing invention has been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. It is contemplated that various aspects and features of the invention described can be practiced separately, combined together, or substituted for one another, and that a variety of combination and subcombinations of the features and aspects can be made and still fall within the scope of the invention. Furthermore, the systems described above need not include all of the modules and functions described in the preferred embodiments. Accordingly, the present invention is not intended to be limited by the recitation of the preferred embodiments, but is to be defined by reference to the appended claims.

What is claimed is:

1. A method for authenticating a user comprising:
obtaining an indication of a biometric parameter using a secured computing device from a user, wherein the indication provides information on the identity of the user;
verifying that the obtained indication of the biometric parameter substantially matches the stored indication of the biometric parameter;
obtaining a first password from the user;
verifying that the first password matches a stored second password;
communicating the identity of the user to a remote host and requesting a salt value;
receiving from the remote host said salt value and a remote host challenge value;
calculating a device challenge value;
calculating a hash using the salt value and first password;
encrypting the remote host challenge value and the device challenge value using the hash;
receiving an unencrypted device challenge value from the remote host;
verifying that the received unencrypted device challenge value is identical to the calculated device challenge value; and
generating a session master secret;
encrypting the session master secret; and
communicating the session master secret to the remote host.

2. The method of claim 1, further comprising initiating the communication between the secured device and the remote host using an unsecured device, wherein the communication path between the secured device and the remote host passes through the unsecured device and wherein the communications are not shared with the unsecured device.

3. The method of claim 1, further comprising storing transaction information on the secured computing device.

4. The method of claim 1, further comprising:
retrieving a stored hash at the remote host;
decrypting the remote host challenge value and the device challenge value using the retrieved stored hash;
determining whether the host challenge value and the device challenge value are identical;
transmitting the unencrypted device challenge value if the decrypted challenge value and device challenge value are identical.

5. A method of providing authenticated and secure electronic communications over an unsecured electronic communication path comprising:
providing a secured device comprising at least a biometric sensor, a user input, and a display; and
wherein the secured device is configured to communicate with a secure network server;
requesting a secure communication value from the secure network server over an unsecured communication path;
receiving at the secured device the secure communication value;
displaying on the display a message;
authenticating a user's identity using the biometric sensor;
encrypting a message using the secured device; and
communicating the encrypted message over the unsecured communication path to the secured network server.

6. The method of claim 5, wherein authenticating a user's identity further comprises authenticating a second user's identity using the biometric sensor.

7. The method of claim 5, wherein the secured device comprises connectable to an unsecured computing platform.

8. The method of claim 7, wherein the unsecured computing platform provides the unsecured network communication path.

9. The method of claim 8, wherein the authentication and encryption device communicates with the secure network sever through the unsecured computing platform without sharing useful information with the unsecured computing platform.

10. The method of claim 5, wherein the biometric sensor comprises a finger or thumb print reader.

11. The method of claim 5, wherein the user input comprises a keypad.

12. The method of claim 5, further comprising calculating an authentication device challenge value and using a salt value to calculate a hash of the salt and receiving a user password entered via the input device to create an encryption key, and encrypting one or more challenge values using said encryption key, wherein said salt value is received from a remote host after said processor has verified said user using data from said biometric sensor

13. A device for providing secure communication through an unsecured system comprising:
a processor configured to calculate an authentication device challenge value and use a salt value to calculate a hash of the salt and a user password entered via the input device to create an encryption key, said processor further configured to encrypt one or more challenge values using said encryption key, wherein said salt value is received from a remote host after said processor has verified said user using data from said biometric sensor;
a display in communication with the processor;
a biometric sensor in communication with the processor configured to obtain biometric information useful in identifying an individual;
an input device in communication with the processor; and
a computer interface configured to provide a communication path between an unsecured computing platform and the processor; wherein the processor is further configured to communicate with a remote host through the unsecured computing platform, wherein the encryption key is not shared with the unsecured computing platform.

14. The authentication device of claim 13, further comprising a non-volatile memory, wherein said processor is further configured to store an audit file in said non-volatile memory.

15. The authentication device of claim 13, wherein said input device comprises a keypad.

16. The authentication device of claim 13, wherein said computer interface comprises a USB interface.

17. The authentication device of claim 13, further comprising an internal power source, wherein said processor is configured to delete selected security data when said computer interface is disconnected from a computer.

18. A system for authenticating a transaction comprising:
an unsecured device configured to initiate a transaction with a secured remote host;
a secure device connectable to the unsecured device and configured to verify a user's identity by obtaining a biometric indication; wherein the secure device is further configured to send and receive encrypted communications with the remote host; and
wherein the encrypted communications pass through the unsecured device without being unencrypted by the unsecured device.

19. The system of claim 18, where the biometric indication is an indication of finger prints.
